(19) United States
(12) Patent Application Publication
(10) Pub. No.: US 2002/0023036 A1
(43) Pub. Date: Feb. 21, 2002

(54) Method of buying and selling real estate

(76) Inventor: Martin G. Meder, Blacksburg, VA (US)

Correspondence Address: MARTIN G. MEDER, 1415 LOCUST AVENUE, BLACKSBURG, VA, 24060, US

(21) Appl. No.: 09/873,040

(22) Filed: Jun. 1, 2001

Related U.S. Application Data
(60) Provisional application No. 60/209,725, filed on Jun. 5, 2000.

(51) Int. Cl. G06F 17/60

(52) U.S. Cl. 705/36

(57) ABSTRACT

A real estate for sale database is configured such that properties that are undervalued because of physical or legal defects or both are identified and preferentially presented. An example of a technique for searching for properties with legal defects for preferential presentation is to provide the records sorted according to the return on investment of a successful tax appeal for properties having an offer price lower than the tax assessment valuation of the real estate. An example of a technique for searching for properties with physical defects for preferential presentation is to provide a predesigned search strategy to look in the property description field for euphemisms for properties in disrepair such as “diamond in the rough” or “handyman's special” or “needs TLC.”

This application claims priority of U.S. provisional patent application serial No. 60/209,725, filed on Jun. 5, 2000.

### FIELD OF THE INVENTION

This invention relates to buying and selling real estate.

### BACKGROUND

Databases of residential real estate for sale are generally organized so that potential buyers are first presented with real estate sorted by the geographical area where the buyer would like to reside, and then sorted by how much the buyer can afford to spend. Examples of such databases include the Multiple Listing Service (MLS, trademark of the National Association of Realtors, available at www.realtor.com), as well as many “for sale by owner” websites. However, both of these criteria are of lesser importance to real estate speculators and real estate investment trusts. Real estate speculators may have no plans to live in a property in a given location for any length of time, or even at all. Real estate speculators are much more interested in being able to identify undervalued properties for purchase and resale.

### SUMMARY OF THE INVENTION

A real estate for sale database is configured such that properties that are undervalued because of physical or legal defects or both are identified and preferentially presented. An example of a technique for searching for properties with legal defects for preferential presentation is to provide the records sorted according to the return on investment of a successful tax appeal for properties having an offer price lower than the tax assessment valuation of the real estate. An example of a technique for searching for properties with physical defects for preferential presentation is to provide a predesigned search strategy to look in the property description field for euphemisms for properties in disrepair such as “diamond in the rough” or “handyman's special” or “fixer-upper” or “needs TLC (tender loving care).”

### DETAILED DESCRIPTION OF THE INVENTION

Records of real estate for sale available for viewing in various databases have indicators of defects in the properties being offered for sale. Two types of defects that can alert an investor to a bargain are legal defects, such as excess property tax valuations, and physical defects such as indications of states of disrepair of the property. They are discussed in turn below.

Real estate is assessed by taxing authorities to estimate the value of a given piece of real estate. This is necessary because the only true way to determine what real estate is worth is to conduct an arm's length sale, the resulting sales price representing the true valuation of the real estate. However, every piece of real estate does not trade every year, making periodic tax assessment valuations necessary. In some jurisdictions 10 years, and even longer, can go by between assessments. The market for real estate is very inefficient and it is very frequent that a property is put on the market that has a tax assessment valuation higher than the offer price of the real estate. This represents an opportunity for speculators and investors. The average buyer will fear that he would risk being committed to paying an unfairly high amount of property tax, if he were to purchase such a property. Fortunately, average individuals overestimate risk, nor do they have the wherewithal to average risk over multiple purchases. The risk is that an appeal of the tax assessment valuation will fail. While it is certainly possible that an appeal of a periodic reassessment associated with an entire community will fail, this is much less likely than an appeal based on an arm's length sale. The reason is that a tax assessment valuation is done as an estimate because the true value of a piece of real estate is not known. Once a sale occurs, the sales price is established as the true value, as is recognized by courts, and courts will generally reduce the tax assessment valuation to, or near, the sales price, as a remedy.

A key piece of information that investors require is return on investment (ROI). Existing databases of real estate for sale, such as the MLS, can be made to provide this. A real estate database comprises records that contain information such as geographic location of a given piece of real estate, the offer price, how much the utility bills are, the annual property taxes that have to be paid, the tax assessment valuation, which is the basis for the amount of property taxes that must be paid, a description of the property, whether there are any houses on it, the condition of any house, how many and what type of rooms a house has and the like. The tax assessed valuation in some jurisdictions sometimes has an arbitrary multiplier, like one-half, as a multiplier to make taxpayers think that their tax is not as bad as it seems. These multipliers can be accommodated, i.e., adjusted back to normal, in an ROI calculation for each jurisdiction in which the real estate in interest is located. Note that the tax assessment valuation is multiplied by a tax rate to obtain the actual property taxes owed.

With the offer price and the tax assessment valuation extracted from a record in the database, an ROI based on a successful tax appeal can be calculated. Then, the records in the database, or a subset of the records, can be sorted according to ROI, as well as other factors such as geographic location and offer price. The results are then displayed so that a decision to buy real estate can be made.

The most important point of the ROI calculation is that the price of a house can be raised once a successful tax appeal is obtained. This is because buyers are qualified according to how much monthly payment they can tolerate. Generally, the maximum monthly payment allowed is about 28 to 36% of the buyer's monthly income. The monthly payment is the property tax, which the mortgage companies pay out of escrow monthly, plus the monthly mortgage payment. If the tax goes down, the monthly mortgage payment can go up, yet the same pool of buyer's will be qualified to buy the real estate. If the monthly mortgage payment can the go up, then the real estate can be offered for resale at a price corresponding to the higher mortgage payment, rather than the original purchase price. In other words, the step of calculating the return on investment substitutes an increased future sales price based on hypothetical increased future mortgage, wherein the property taxes saved by a hypothetically successful tax assessment valuation appeal allow for an increased mortgage.

Of course, the real estate does not have to be resold to obtain an economic benefit, paying fewer taxes is a reward even for non-investors. Also, the reduced taxes support a higher valuation for purposes of obtaining a home equity loan, for example. So to a first approximation, the ROI can be estimated to be a mortgage with a monthly payment equivalent to the taxes saved by reducing the tax assessment valuation to the sales price, divided by the money invested. The sales price is not obtainable from the record, but the offer price can be used as a good approximation, or it can be reduced by a percentage like 10% to reflect what is common in the market as a differential.

The money put forward by an investor used to buy real estate is generally in the form of a deposit of 5, 10 or 20% of the sales price when the investor is obtaining a mortgage, but it can be 100% cash. The investor, after purchase, appeals the tax assessed valuation and after a time resells the house. The time selected can be arbitrary, such as one year, for an easy annualized ROI calculation, and as it will apply equally to every real estate record examined in the database. Two years is a particularly preferred choice because current law allows profits to be taken up to $250,000 or $500,000 tax free after a single buyer or married buyers respectively occupies the real estate for that time.

In practice, some real estate purchases are too small to contemplate because of frictional costs. These frictional costs are subtracted from expected resale price as a further refinement on the ROI calculation. The frictional costs are of two types: those that are a function of the sales price of the real estate and those that aren't. Frictional costs that depend on the cost of the real estate generally include real estate commissions, transfer taxes, loan origination fees, property taxes, school taxes, refuse charges, points, mortgage insurance if any, mortgage payments, flood insurance, liability and damage insurance, title insurance and the like. Customary percentages may be assumed for the purposes of calculating an ROI since applying an approximate percentage to all records examined is not expected to much affect the ordering of desirability of buying a given piece of real estate. Six percent is typical for real estate commissions and one percent may be used as a transfer tax. Current mortgage rates may be used to calculate the mortgage payments and also the effect of trading tax payments for mortgage payments.

Frictional costs that do not depend on the sales price will make some investments uneconomical even if the tax assessment valuation is higher than the offer price. These generally include attorneys fees, engineering inspections, termite inspections, radon tests, percolation tests, appraisal fees, credit reports, processing fees, notary fees, flood zone determination fees, tax service fees, tax certifications, overnight mail, endorsements, recordation fees, and the like. A sum of all of these typical for a given jurisdiction may be used in the ROI calculation without unduly affecting the rankings of records.

The ROI calculation is illustrated in the following by way of an example.

### EXAMPLE

A piece of real estate is offered for sale at $250,000. The assessed valuation for tax purposes is $500,000 and the annual taxes associated with the assessed valuation are $9,000. The monthly taxes due are $750. A buyer purchases the real estate at the offer price with a 10% deposit of $25,000, and successfully has the tax assessment reduced to the offer price. The annual taxes owed are now $4,500 or $375 per month, which is $375 dollars less a month than before the appeal. The monthly mortgage payments can be increased to that amount and the real estate would still be available for purchase to the same buyers that were qualified for the earlier sale. At 8% interest, a 30-year, $51,000 mortgage can be had for the $375 payments. Therefore, the real estate can be resold for $250,000 plus $51,000 or $301,000. The buyer then resells the real estate six months after he purchased it. The buyer has made $51,000 that he would not have made if he had bought a house that was fairly assessed. The buyer has invested $11,006 over the six months on his own mortgage of 8%, his deposit being returned in the resale. So, the buyer has obtained in six months a return on investment of 65%, annualized would be about double that.

More accurately, including frictional costs preferably refines the above calculation. A six- percent real estate sales commission and a one- percent commission would add $21,070 to the cost of a $301,000 sale. Two attorney's fees (once as buyer, then as seller), taxes for six months, insurance, inspections and the like could add another $5,000, raising the total frictional cost to $26,070. The total invested would then be $37,006 to obtain $51,000 after six months. The ROI would then be 38%; about double that when annualized.

Such a frictional ROI calculation as described above is preferably done for every record examined in a database where the tax assessment valuation exceeds the offer price. Assumptions about interest rates and frictional costs will vary with time and location, and can be so adjusted, but it is not expected that the sorting order of the records will be much affected, so long as the assumptions are reasonable.

Real estate database records also generally contain indications of physical defects, such as states of disrepair, of the property being described. These indications are generally couched in terms of euphemisms such as “diamond in the rough” or “handyman's special” or “fixer-upper” or “needs TLC (tender loving care).” Records containing these terms may be preferentially displayed by invoking a predesigned Boolean keyword search of a property description field of records in database such as: “diamond” OR “fixer” OR “upper” OR “TLC” OR “handyman”.

The techniques of the present invention may also be employed by real estate investment trusts in searching for real estate to invest in.

Note that the present invention can also benefit commercial real estate databases.

Also, the sorting on legal and physical defects described herein may be used with each other or in conjunction with sorting by offer price or location.

The databases corresponding to the various embodiments of the present invention may be stored on computer-readable media.

Although various embodiments of the invention are shown and described herein, they are not meant to be limiting, for example, those of skill in the art may recognize certain modifications to these embodiments, which modifications are meant to be covered by the spirit and scope of the appended claims.

I claim:

1. A method of buying real estate comprising:
extracting from a real estate for sale database the offer price, annual property taxes due and tax assessment valuation from each of a plurality of real estate records;
calculating the return on investment of a successful tax appeal of the tax assessment for each of a plurality of records;
sorting the plurality of records according to the return on investment of each record of the plurality of records; and
displaying the sorted records so that a decision to buy real estate may be made.

2. The method of claim 1, wherein the plurality of records is a subset of total records in a real estate database, the plurality of records comprising records that have tax assessment valuations greater than the offer price.

3. The method of claim 1, wherein the plurality of records is a subset of total records in a real estate database, the plurality of records comprising records that have also been sorted for geographic location.

4. The method of claim 1, wherein the plurality of records is a subset of total records in a real estate database, the plurality of records comprising records that have also been sorted for offer price.

5. The method of claim 1, wherein the step of calculating the return on investment substitutes an increased future sales price based on hypothetical increased future mortgage, wherein the property taxes saved by a hypothetically successful tax assessment valuation appeal allow for an increased future mortgage.

6. The method of claim 1, wherein the step of calculating the return on investment includes frictional costs.

7. A method of buying real estate, comprising:
sorting a plurality of records in a real estate for sale database according to an the existence of an indication of a state of disrepair; and
displaying the sorted contents so that a decision to buy may be made.

8. The method of claim 7 wherein the indication of a state of disrepair is the existence of a euphemism for a state of disrepair in the description of property in a record.

9. The method of claim 7, wherein the indication of a state of disrepair is the existence of a euphemism for a state of disrepair in the description of property in a record, and wherein a search term for the euphemism is selected from at least one of diamond, fixer, upper, TLC and handyman.

10. The method of claim 7, wherein the plurality of records is a subset of total records in a real estate database, the plurality of records comprising records that have also been sorted for geographic location.

11. The method of claim 7, wherein the plurality of records is a subset of total records in a real estate database, the plurality of records comprising records that have also been sorted for offer price.

12. A real estate investment trust comprising:
investments in real estate, wherein the real estate invested in is selected at least in part by:
sorting the records of a real estate for sale database on an indication of a defect in the real estate; and
displaying the sorted contents so that a decision to buy may be made.

13. The real estate investment trust of claim 12, wherein the defect is a tax assessment valuation of the real estate in excess of the offer price.

14. The real estate investment trust of claim 12, wherein the defect is a tax assessment valuation of the real estate in excess of the offer price and wherein the real estate invested in is selected at least in part by:
extracting from a real estate for sale database the offer price, annual property taxes due and tax assessment valuation from each of a plurality of real estate records;
calculating the return on investment of a successful tax appeal of the tax assessment for each of a plurality of records;
sorting the plurality of records according to the return on investment of each record of the plurality of records; and
displaying the sorted records so that a decision to buy real estate may be made.

15. The method of claim 14, wherein the plurality of records is a subset of total records in a real estate database, the plurality of records comprising records that have tax assessment valuations greater than the offer price.

16. The method of claim 14, wherein the plurality of records is a subset of total records in a real estate database, the plurality of records comprising records that have also been sorted for geographic location.

17. The method of claim 14, wherein the plurality of records is a subset of total records in a real estate database, the plurality of records comprising records that have also been sorted for offer price.

18. The method of claim 14, wherein the step of calculating the return on investment substitutes an increased future sales price based on hypothetical increased future mortgage, wherein the property taxes saved by a hypothetically successful tax assessment valuation appeal allow for an increased future mortgage.

19. The method of claim 14, wherein the step of calculating the return on investment includes frictional costs.

20. The real estate investment trust of claim 12, wherein the defect is an indication of disrepair.

21. A method of buying real estate, comprising:
sorting a plurality of records in a real estate for sale database according to an the existence of a legal defect in the real estate; and
displaying the sorted contents so that a decision to buy may be made.

22. The method of buying real estate of claim 211 wherein the legal defect is a tax assessment valuation of the real estate in excess of the offer price.
